(19) United States
(12) Patent Application Publication
(10) Pub. No.: US 2026/0132966 A1
(43) Pub. Date: May 14, 2026

(54) SOLAR COLLECTION PLATFORM PROVIDING MULTI-DRIVE FRESNEL LENS TRACKERS FOR SEQUENTIAL HEAT COLLECTION

(71) Applicant: Exowatt, Inc., Miami, FL (US)

(72) Inventors: Kiran Kambly, Miami, FL (US); Sushrut Bapat, Miami, FL (US); Pedro Neves, Miami, FL (US); Ehsan Ordouie, Miami, FL (US); Hannan Parvizian, Miami, FL (US); John M DeLappe, Miami, FL (US); Christopher Rengifo, Miami, FL (US); Simon Shuham, Miami, FL (US)

(21) Appl. No.: 19/323,737

(22) Filed: Sep. 9, 2025

Related U.S. Application Data
(60) Provisional application No. 63/692,663, filed on Sep. 9, 2024.
(60) Provisional application No. 63/692,686, filed on Sep. 9, 2024.

(51) Int. Cl. F24S 30/425; F24S 10/00; F24S 23/30; F24S 50/20; F24S 60/00

(52) U.S. Cl. CPC F24S 30/425; F24S 10/00; F24S 23/31; F24S 50/20; F24S 60/00

(57) ABSTRACT

A solar collection platform comprises a first heating stage providing a first heated medium output; a second heating stage thermally coupled to receive the first heated medium output, the second heating stage further heating the first heated medium output to provide a second, cumulative heated medium output; wherein the first and second heated stages are incorporated into a standard sized shipping container form factor containing a distributed thermal storage, and the first and second heating stages each comprise rotatable Fresnel lens arrays with single axis tracking. A rugged Fresnel lens panel support structure changes the elevational orientation of the panels in a single degree of freedom to track the changing position of the sun's elevational. Longitudinal linear adjustment of the panels' position corrects focal point for the sun's seasonal azimuth changes at low angles to increase efficiency.

### CROSS-REFERENCES TO RELATED APPLICATIONS

This application claims benefit of U.S. Provisional Patent Application No. 63/692,686 filed Sep. 9, 2024 and U.S. Provisional Patent Application No. 63/692,663 filed Sep. 9, 2024, each of which is incorporated herein by reference in its entirety and for all purposes.

This application is related to the following commonly-assigned copending applications each of which is incorporated herein by reference:

“Thermal Battery Pack” (Attorney Docket No. 8839-27), application no. 63/692,681 filed Sep. 9, 2024;

“Thermal Battery Pack Recirculating Housing” (Attorney Docket No. 8839-28), application no. 63/692,684 filed Sep. 9, 2024 and application Ser. No. ______ filed on date even herewith (Attorney Docket No. ______) (collectively “Thermal Battery Pack Recirculating Housing”);

“Integrated Thermal Energy Collection, Storage, and Discharge Device” (Attorney Docket No. 8839-25), application no. 63/692,688 filed Sep. 9, 2024 and application Ser. No. ______ (Attorney Docket No. ______) filed on date even herewith; and Application No. 63/686,611 filed Aug. 23, 2024 and application Ser. No. 19/308,157 filed on Aug. 22, 2025 (Attorney Docket No. 8839-48), each entitled “Hot-Gas Free-Piston Stirling Engine With Efficient Hot Air Inlet.”

### STATEMENT REGARDING FEDERALLY SPONSORED RESEARCH OR DEVELOPMENT

None.

### FIELD

The technology herein relates to generating and storing high temperature heat from a sequential heat collection and storage system. The technology further relates to a modular approach to such a sequential heat collection system. The technology herein also relates to collection of thermal energy, and to solar collectors that collect solar energy and produce electrical and thermal output power. More particularly, the technology relates to a thermal collector providing a simple and rugged mechanical structure that rotates the collectors about a single axis to track the position of the sun as the sun moves in the sky.

Renewable energy availability is intermittent which will hinder the transition towards a more sustainable energy infrastructure. The technology herein provides a power generation system and storage device that is fueled by the sun and operated by air or other thermal transfer fluid.

We all know the sun rises in the east and sets in the west. We also know the times the sun rises and sets are based on the time of year and our location on the earth's surface. For example, days grow shorter in the northern hemisphere as the winter solstice approaches and they grow longer as we approach the summer solstice. Meanwhile, in the southern hemisphere it is just the opposite—as the days are growing longer in the northern hemisphere they are growing shorter in the southern hemisphere and vice versa. There are always twelve hours of daytime and twelve hours of night-time at the equator, except for two minor effects that increase daytime by about eight minutes. Most of us probably vaguely know these changes have to do with the tilt of the earth relative to the sun which is responsible for changing seasons in the northern and southern hemispheres.

Yet, the path the sun takes in the sky is actually a bit more complicated. For example, the sun takes an arc across the southern sky from locations north of the equator and takes an arc across the northern sky from locations south of the equator. The exact angle and arc depends on the latitude of the observer and the time of year.

Not only is the earth tilted on its axis relative to the sun, but the earth is also orbiting the sun in a path that is elliptical rather than circular. Orbiting in an ellipse doesn't just mean that the Earth is closer to or farther from the Sun at certain points in its orbit. It also by Kepler's second law means that when the Earth is close to the Sun (perihelion), it possesses a faster orbital speed, and when the Earth is far from the Sun (aphelion), it possess a slower orbital speed. The effects together mean that during the course of a year, if you took the sun's position every day at the same time you would see that the sun traces an analemma or figure eight in the sky. We can intuitively understand this by remembering that the angle of light during the winter seems to be different (the sun's arc is lower in the sky in the northern hemisphere and higher in the sky in the southern hemisphere) than the angle of light during the summer.

Meanwhile, the Earth doesn't rotate once on its axis every 24 hours. Instead, the Earth makes a full 3600 rotation in just 23 hours and 56 minutes. A day takes 24 hours because it takes those extra 4 minutes to “catch up” to the amount of distance the Earth has traveled in its orbit around the Sun. During an average day, when the Earth moves at its average speed around the Sun, 24 hours is just right. But when the Earth moves more slowly (near aphelion), 24 hours is too long for the Sun to return to its same position, and so the Sun appears to shift more slowly than average. Similarly, when the Earth moves more quickly (near perihelion), 24 hours isn't quite long enough for the Sun to come back to where it started, and so it shifts more quickly than average.

All of this makes for a complex but very predictable path the sun will take across the sky on any given day of the year at any given location on the earth's surface but which will change from one day to the next. See e.g., Siegel, “This Is How The Sun Moves In The Sky Throughout The Year” (Forbes 2019), www.forbes.com/sites/startswithabang/2019/01/01/this-is-how-the-sun-moves-in-the-sky-throughout-the-year/?sh=48c77e7a7303

A solar collector should optimally be always aimed directly at the sun in order to maximize the energy it collects. This is why solar collectors are typically designed to track the sun's position. Ideally, the solar collector should track in two degrees of freedom (both azimuth and elevation) so it can aim precisely at the sun's position. Two different actuators (one for the azimuth, another for the elevation) can be controlled independently to move the solar collector to the precise orientation it needs to be in to aim at the sun. A computer including a real time clock/calendar can automatically control the position of the collector so it frequently updates its orientation as the sun moves across the sky.

However, dual axis tracking increases complexity and cost. While the theory of automatic solar tracking is straightforward, a challenge is to construct single axis tracking drives, actuators and support frames for solar collectors that are rugged, reliable and inexpensive. This problem gets worse as the size and number of solar collectors increase. A simpler, rugged single axis tracking design that takes off-axis incidence of the sun's rays into account would be highly useful and desirable.

Further challenges relate to efficiently coupling and storing energy collected by a solar collector. Various technologies are known, including large heat retaining masses such as graphite or clay. But significant challenges are involved in deploying such thermal storage devices in a way that efficiently couples solar collectors to the storage devices and also allows heat the storage devices store to be efficiently coupled to thermal loads.

### BRIEF DESCRIPTION OF THE DRAWINGS

Features and advantages of example embodiments will be better and more completely understood by referring to the following detailed description of exemplary non-limiting illustrative embodiments in conjunction with the drawings of which:

FIG. 1 is a schematic block diagram of a solar collection platform.

FIG. 2 shows a further schematic diagram of a solar collection platform.

FIG. 3 shows an elevated view a solar collection platform first embodiment.

FIG. 4 shows an elevated view of a solar collection platform second embodiment.

FIG. 5 is a schematic diagram of an electronic controller.

FIGS. 6A, 6B, 6C are together a flip chart animation showing single axis tracking.

FIGS. 7A, 7B, 7C are together a flip chart animation showing single axis tracking and focal length adjustment.

FIGS. 8, 9 and 10 show side perspective views of an embodiment of a SCP.

FIGS. 8A and 9A show elevated perspective views of another embodiment of an SCP.

FIG. 11 shows a birds eye view.

FIG. 12 shows an elevated first end view.

FIG. 13 shows an elevated second end view.

FIGS. 14 & 15 show example internal mechanical details.

### DETAILED DESCRIPTION OF EXAMPLE NON-LIMITING EMBODIMENTS

Example embodiments collect and store high temperature heat using a modular sequential and/or progressive solar heat collection system.

One example embodiment provides a system comprising: a first heating module providing a first heated medium output; a second heating module thermally coupled to receive the first heated medium output, the second heating module further heating the first heated medium output to provide a second, cumulative heated medium output; wherein the first heating module and the second heating module may each comprise modular solar heating stages that are part of a progressive solar heating system.

In example embodiments, each module may itself comprise a sequential collection system which comprises of a linear array of tracking Frensel lenses and an associated progressive absorber that achieves high-temperature heat collection and storage.

An example non-limiting design delivers cost-effective technology for high-temperature heat capture with a Fresnel Lens concentrator, an absorber(s) coupled to a block based thermal energy storage system (TESS) and a hot-gas operated Stirling engine. The Fresnel Lens concentrator is mounted in a single-axis multidrive tracker drive that can provide up to 80% optical system effectiveness when compared to classical dual-axis tracker, however, with substantially reduced mechanical complexity. In one embodiment, each module delivers 5 kW of electric power for 8 hours per day. The module contains built-in electrical cartridge heaters to assist TESS to hold charge level during days where the solar resource is limited or unavailable.

Example embodiments further provide a high natural frequency tracker solution for Fresnel lens applications. Example embodiments track a series of point-focus Fresnel Lenses for sequential or other heat collection while maintaining high-natural frequency for high-wind loads.

A multi-drive or a single-drive balanced design provides a straightforward way of tracking Fresnel lenses for such environmental demands. Other drives are used for improving the tracker effectiveness. Effectiveness is defined as the ratio of concentrated energy delivered through an aperture to the energy provided by the sun on the tracker.

Non-limiting advances include improved wind stability, improved optical effectiveness, a unique concept around utilizing Fresnel lens and single axis tracking, and harvesting energy with active focal point tracking.

In one aspect, a solar collector comprises a heat absorber; an array of lens panels carried by at least one frame; a frame support enabling the lens panels to rotate; a single-axis automated drive mechanism connected to the frame support, the single-axis automated drive mechanism rotating the frame support to track, based on season, elevation of the sun with a field of view of the lens panels; and a focal position control enabling linear adjustment of position of focal point onto the heat absorber to account of azimuth position changes of the sun.

The heat absorber comprises a linear array.

The lens panels comprise Fresnel lens panels.

The focal position control is automatic or manual.

The single-axis automated drive mechanism comprises a tracking computer connected to an electromechanical drive.

The array of lens panels comprises a longitudinal array of many lens panels aligned on a longitudinal axis.

The heat absorber comprises a thermal battery.

The single axis automated drive mechanism rotates the frame support to thereby rotate the array of lens panels through a range of elevation angles from dawn to dusk.

In another aspect, a solar collection method comprises providing an array of lens panels carried by at least one frame supported by a frame support enabling the lens panels to rotate; automatically rotating the frame support in a single axis to track, based on season, elevation of the sun with a field of view of the lens panels; and enabling adjustment of linear position and rotational orientation between the frame support and a heat absorber.

The heat absorber comprises a linear array.

The lens panels comprise Fresnel lens panels.

The adjustment enabling is automatic or manual.

The automatically rotating is performed by single-axis automated drive mechanism comprising a tracking computer connected to an electromechanical drive.

The array of lens panels comprises a longitudinal array of many lens panels aligned on a longitudinal axis.

The heat absorber is coupled to a thermal battery.

The solar collection method of claim 10 wherein the automatically rotating comprises rotating the frame support to thereby rotate the array of lens panels through a range of elevation angles.

### Example Modular Solar Collection and Storage System

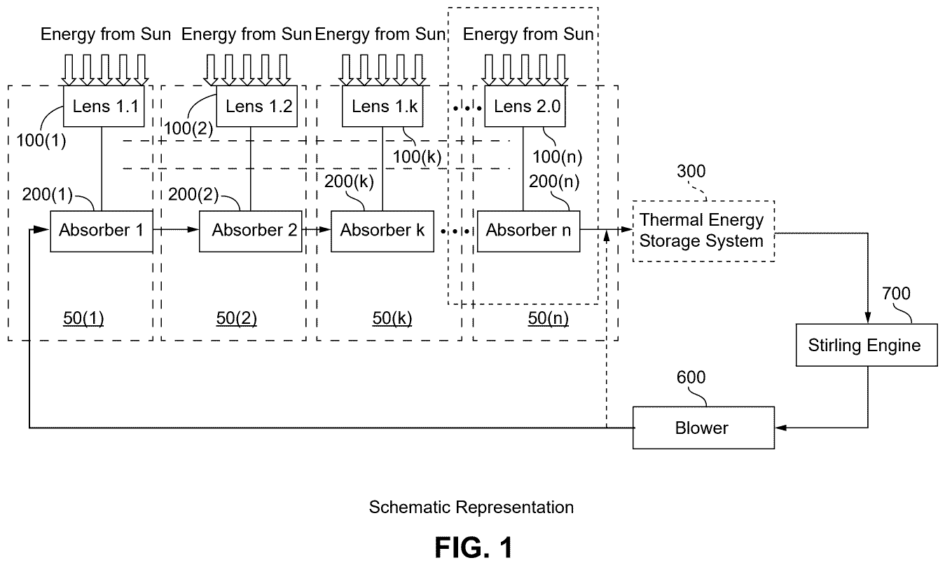

FIG. 1 is a schematic view of an example non-limiting design of a solar collection platform (SCP). The example shown has a series of solar thermal collector stages 50(1), 50(2), . . . , 50(k), . . . , 50(N). Each solar collector stage 50 comprises a solar collecting lens arrangement such as a Fresnel lens panel 100 and an associated heat absorber 200. Each lens arrangement 100 concentrates and focuses the sun's energy onto a respective heat absorber 200.

In the example shown, the lenses/heat absorbers 100/200 are arranged in a sequence of heating stages 50 to increase capacity. There can be as many stages 50 as desired stacked or sequenced in this manner to progressively raise the temperature of a heated working fluid to a desired temperature at a given flow rate. In other words, k can comprise any non-negative integer such as 1, 2, 3, . . . . As noted below, the heat absorbers can be continuous or discrete to provide a desired progressive heating effect.

In one example embodiment, each of the thermal collector stages 50(1), 50(2), . . . 50(k) are identical in construction and operation. However, as the temperature of working fluid progressively increases, higher temperature rated components may be needed to withstand the higher temperature. Accordingly, in the example shown, a late stage(s) 50(n) comprising lens 100(n) and absorber stage 20(n) may comprise different structures that can withstand higher temperatures. In particular, the absorber n or structure associated with the absorber may comprise higher temperature components. There may be more than one late stage or as many late stages as needed to raise the temperature of the media to a desired temperature suitable for a particular thermal load such as a Stirling engine 700.

In terms of progressive heating, in one embodiment each lens 100 and associated absorber 20 can be essentially identical in capability. The heat output of a first absorber 20 can flow through a second absorber, the heat output of the cumulative first and second absorbers can flow through a third absorber, and so on, to provide progressive heating of a working fluid to a desired temperature.

### Thermal Storage Capabilities

Solar collection systems of any type need to deal with reality that the sun only shines during the day and does not shine at night. Due to the earth's rotation relative to the sun, a solar collection is exposed to sunlight for only a certain number of hours during the day, the number of hours varying by season in temperate and high latitudes. During times when the sun is not shining on the collectors due to time of day, weather, etc., it may be desirable to nevertheless continue to provide uninterrupted heat output to a thermal load such as a Stirling engine 700. Providing such uninterrupted heat output entails some means for storing thermal energy collected by the collection stages 50 for consumption by the thermal load during periods when the sun is not shining on the collector stages.

In the example shown, an optional additional thermal energy storage 300 can be provided to store heat collected by the system. In one embodiment as explained below, the absorbers are thermal battery cells that can retain and release heat, and they can be connected in series (just as electrical battery cells can be connected in series) to increase the thermal output temperature/quantity of heat carried by the working fluid.

FIG. 1 shows an additional thermal storage 300 as a discrete thermal storage placed at the end or output of stages 50. However, there can be challenges with an approach where all of the energy from the collection system is stored in a thermal energy storage system at the end of a collection chain. In particular, in such a system, heat is transported from each of collection stages 50 to the end-of-the-line thermal energy storage system 300 where it is stored and then later released. Heat is inherently lost in such transport.

To overcome such challenges and increase collection efficiency, example embodiments distribute thermal energy storage throughout the system so that each collecting stage 50 is close to a device that absorbs and stores heat generated by that collecting stage. Accordingly, in example embodiments herein thermal storage is distributed such that each stage 50 includes its own respective thermal storage. Furthermore, in example embodiments, thermal energy collected by a collection stage 50 is directly impinged onto the thermal storage associated with that collection stage. In other words, in the FIG. 1 arrangement, each absorber 200 absorbs energy and also provides storage for reasonably long periods of time (e.g., 24 hours, 48 hours or longer). Thus, inefficiency and loss of thermal energy due to transport is minimized since the same component that receives thermal energy from a solar collector stage also stores that thermal energy local to that solar collector stage.

In some embodiments, there can be distributed thermal storage components within each stage 50 as described, and heat from those distributed thermal storage components may be fed from the distributed thermal storage components to an additional longer term thermal storage component 300 as shown (e.g., to store heat overnight when the stages 50 are not illuminated by the sun's rays). In other embodiments, there is no additional thermal energy storage system 300, and the entire energy storage capability of the system is distributed close to the collector stages 50. And in still other embodiments, the absorber 200 in a given stage simply acts as an absorber and heat exchanger that transfers absorbed heat to a working fluid that transports the heat to a thermal load 700 either directly or via an intermediate thermal energy storage system 300. In other words, all of the following configurations are possible in example embodiments for each or any given collector stage 50 in any combination:

| Thermal Storage at | Thermal Storage Remote |
|---|---|
| Collector Stage? | from Collector Stage? |
| No | No |
| Yes | No |
| No | Yes |
| Yes | Yes |

In example embodiments, the thermal load may be a Stirling engine 500. Such a Stirling engine 500 in one embodiment converts heat from the thermal energy storage into mechanical energy which then operates an electrical generator that produces electricity. The Stirling engine 500 may have a structure such as that disclosed in “Hot-Gas Free-Piston Stirling Engine With Efficient Hot Air Inlet” referenced above.

In the embodiment shown, the air or other working fluid exhausted after being used to heat the Stirling engine 500 (the Stirling engine itself is a closed system and produces no exhaust as an internal combustion engine might) is recirculated via a blower or pump 600 to the distributed and/or remote (end-of-the-line) thermal storage. The thermal storage may in turn recirculate heated working fluid to staged heat collectors 50 so the first stages 100(1), 200(1) receive preheated media (e.g., at 550 degrees C. or some other temperature) as a starting point. This avoids releasing heat to the environment thereby conserving energy and avoiding waste and heat pollution. In such recirculating embodiments, the distributed and/or lump thermal storage can be used to store such excess heat for recycling back into the thermal engine, e.g., during times when the sun is not illuminating the lens panels. Flow rates and thermal storage capabilities can be optimized to provide ideal working temperatures for the thermal engine 700.

A Stirling engine operates based on an internal temperature difference. The ideal temperature for operating a Stirling engine provides a temperature difference within the Stirling engine that depends on the engine's specific design, application, and the materials used. Low-temperature-difference (LTD) engines can operate with a difference of around 20-30° C., but most medium and high-power, high-efficiency engines often require a larger temperature difference, with hot-side temperatures potentially ranging from 686° C. to over 800° C. or more, and cold-side temperatures around 65° C. Once again, different Stirling engine designs will have different temperature operating ranges and require different temperature deltas for highest efficiency. Theoretical maximum efficiency is given by the Carnot rule (which depends on (1−T_{COLD}/T_{HOT}) with temperatures in Kelvin).

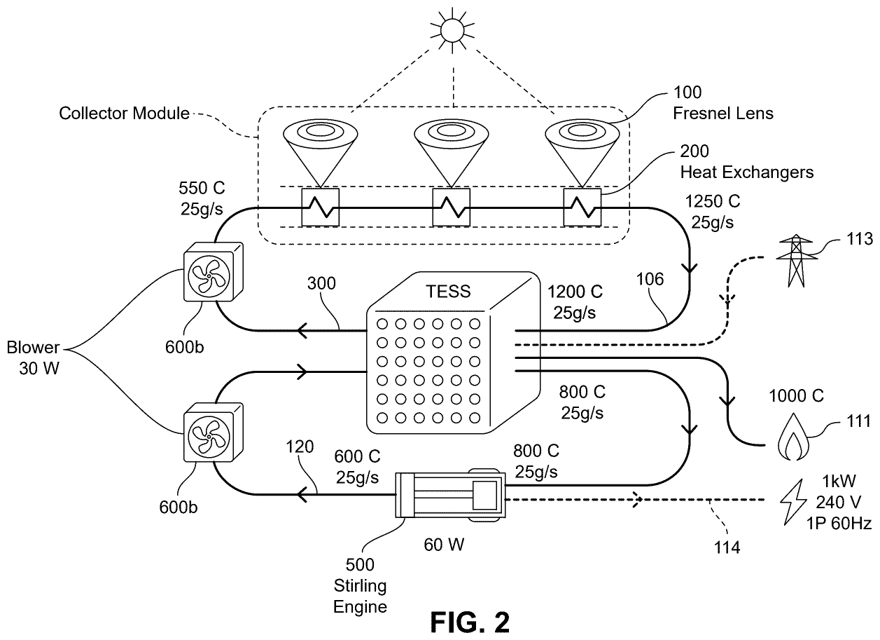

FIG. 2 is another view of a progressive heat-collection system design that utilizes a combination of one or more Fresnel lenses 100 and associated heat absorbers 200 to collect high-temperature heat. The Fresnel lenses 100 may each comprise a flat glass panel etched with a Fresnel pattern to provide a solar heat collection. Solar energy incident on each Fresnel lens 100 is concentrated by the Fresnel lens on an associated absorber 200. In one embodiment, absorber 200 could consist of or comprises a linear, continuous insulated-multi-channel heat exchanger that transfers this concentrated heat to transfer fluid that flows through the system's ductwork 106. In other embodiments, the absorbers 200 can be discrete and distributed and act as thermal battery cells, with one absorber at the focal point of each Fresnel lens 100 and using a series of interconnected channels to transport heat through the system. In some such embodiments, each such discrete absorber itself constitutes, and/or is thermally coupled to, a local thermal storage element, and the thermal storage elements are thermally coupled together with a working fluid such as a gas (e.g., air). The transfer fluid flowing through ductwork/channels 106 carries and delivers the heat to an additional, optional thermal energy storage system (“TESS”) 300, where it can be stored for long duration periods and/or fed to Stirling engine 500 to produce electricity and/or any other thermal load such as an absorption chiller, an oven or any manufacturing application requiring heat.

The heat stored in the thermal energy storage system 300 can thus be dispatched to a power conversion system 110. Also shown in FIG. 2 is an electrical input 113 from the power grid that can be used to generate heat (e.g., through electrical heating elements embedded in the thermal storage components) to heat the TESS 300 when heat from the sun is inadequate. In some embodiments that use distributed thermal storage within each collection stage, there can be distributed electric heating elements associated with the distributed thermal storage components to convert electricity to heat for storage in the distributed thermal storage components.

After the power conversion system 110 converts heat to electricity, the remaining heat in the transfer fluid exits the power conversion system with a lower temperature (e.g., at 120 degrees C.) and is circulated back to the progressive heat-collection system or to the distributed and/or lump TESS 300 for continuous recycling. One or more blowers or pumps 600 may be used to provide circulation and recirculation. In particular, the output of blower 600b shown can be directed to either the TESS 300 or to the chain of thermal collectors 100/200 or both.

In one embodiment, the thermal energy storage system 300 contains insulated thermal energy blocks that are arranged in series/parallel configuration to store the energy required for off-sun hours of system operation.

In one embodiment, the power conversion system comprises one or more Stirling engines 500 that accept the heat from the incoming transfer fluid and convert it to electricity 114 and low-temperature heat.

In one embodiment, the electricity 114 can be used to provide electrolysis of steam also produced by heat from the solar collection system.

The sequential or progressive nature of heat collection allows the system to be scalable for any power conversion unit capacity. The system is extremely flexible in layout and modular for ease of integration and installation.

For example, although FIG. 2 shows three Fresnel lens/absorber 100/200 stages, there can be any number of such combinations such as one Fresnel lens/absorber stage 100/200, two Fresnel lens/absorber stages 100/200, three Fresnel lens/absorber stages 100/200, four Fresnel lens/absorber stages 100/200, five Fresnel lens/absorber stages 100/200, six Fresnel lens/absorber stages 100/200, . . . , or N Fresnel lens/absorber stages 100/200 where N is any positive integer. In the example shown, the thermal fluid flows through the three Fresnel lens/absorber stages 100/200 in series, but in other embodiments the thermal fluid can flow through such units in parallel, or some of the thermal fluid can flow through two or more such units in series whereas other thermal fluid can flow through such units in parallel to provide a series-parallel combination. The number of such Fresnel lens/absorber stages 100/200 can be determined by the power output required. In the example shown, the system as configured is 3×3 (m) with a minimum output of 6.5 kW per lens (4×) but other configurations are possible depending on particular requirements. In one embodiment this can be implemented by making a continuous linear absorber 200 a desired length and providing enough frame-mounted Fresnel lenses to illuminate that desired length with focused solar energy.

The system shown integrates a solar generation system with a larger TESS 300, and a smaller Power Conversion Unit (PCU) 500. A controller automatically rotates a single axis tracking frame(s) holding the Fresnel lenses 100 about the axis of the absorbers 200 as the sun moves in the sky to track the sun's elevational position and continually focus the sun's rays onto the absorbers 200.

The energy collected from the optical system is transferred to the heat transfer fluid flowing through the absorbers 200 where the transfer fluid exit temperature can be e.g., at 1200° C. or above. To accommodate for the variability in the solar resource, the transfer fluid flow rate is modulated to maintain the desired exit temperature. The transfer fluid transfers this energy to the TESS 300 through a heat exchanger/storage for further use.

### Example Modular Implementation

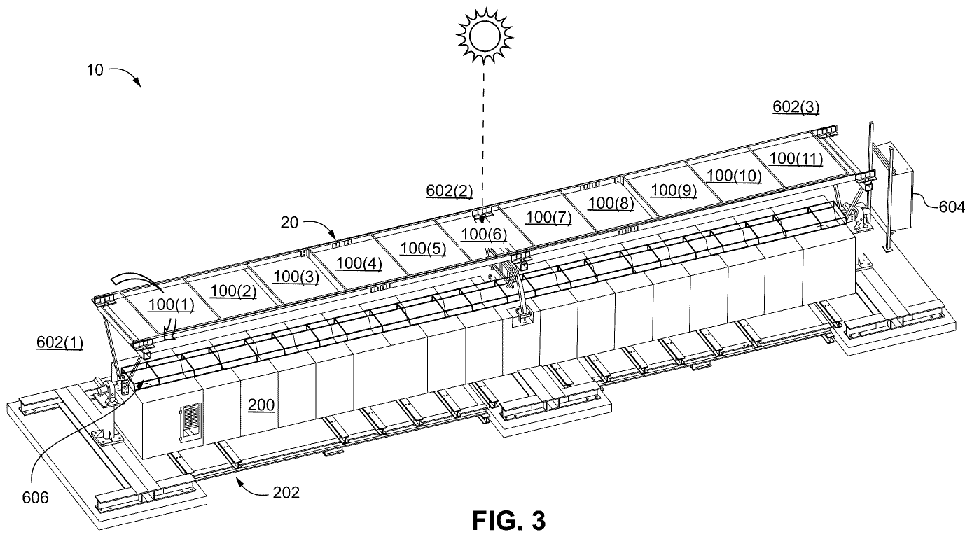

FIGS. 3 & 4 show two different implementations of modular solar collection platforms (SCPs) 10, 20 respectively. In the embodiments shown, each SCP 10, 20 includes an elongated housing 200 supported by a ground frame 202. The elongated housing 200 supports a linear array of Fresnel lenses 100. The linear array of Fresnel lenses 100 are held and encased in and supported by a movable frame(s) 600. In example embodiments, the movable frame(s) 600 is/are rotatable about the longitudinal axis of the elongated housing 200. A drive(s) 604 is provided to rotate the movable frame(s) 600 about that longitudinal axis.

In particular, FIG. 3 shows an example top perspective view of a solar collector array moveable in a single axis to follow the elevational position of the sun. As shown in the drawing, the array includes plural planer collectors which in one embodiment may comprise arrays of planer Fresnel lenses that each receive solar rays from the sun and diffract or bend (concentrate) the solar rays to a thermal and/or optical collection device. The Fresnel lens structures can be made of glass, polycarbonate plastic, acrylic plastic or any other suitable material. See e.g., Xie et al, “Concentrated solar energy applications using Fresnel lenses: A review,” Renewable and Sustainable Energy Review Volume 15, Issue 6, August 2011, Pages 2588-2606, doi.org/10.1016/j.rser.2011.03.031. In the example shown, the Fresnel lens arrays are each long rectangular panels but they can be of any shape, size and dimensions. In the example shown, the Fresnel lens panels are mounted to upright posts that may extend upwards from a support structure (which can be terrain or any other support surface or structure). The single axis tracking system is configured so that the sun's incident rays are continually in a direction relative to the lens panels that is normal to the lens panels. The tracking system ensures this normal orientation of the sun's rays relative to the panels as the sun changes position in the sky from dawn to dusk. Since the single axis tracking will generally not provide normal orientation at low angles of the sun (just after dawn and just before dusk), some embodiments provide an additional, linear focal position adjustment as explained below.

In one embodiment, the thermal collectors 100/200 provide a modular arrangement where multiple thermal collections comprise or provide a module. In such embodiments, it is possible to swap out or interchange one module for another, to add modules or to subtract modules. In one example embodiment, the SCP housing 200 may be dimensioned as a standard 40-foot shipping container (40 feet long, 8 feet wide, and 8.5 feet tall) that can be loaded onto a standard tractor-trailer for transport. Each module can be deployed individually, or multiple such modules can be deployed together and coupled together to provide a higher capacity system.

### Example Single Axis Tracking

In one embodiment, the elevational orientations of the frame structures mounted to the vertical posts may be rotated in one dimension (e.g., elevation) by rotating the frame structures about their longitudinal axis. As the angle of the upright posts changes relative to the horizon, the frame structures and thus the Fresnel lenses change their elevational orientation relative to the horizon. The structure shown is ganged so several such uprights may be connected or ganged to rotate together by a common drive. The upright posts and associated drive or drives connected thereto thus retain the frame structures and the Fresnel arrays they support in a current position and can change the orientation of the frame structures based on movement of a drive(s) or actuator(s). As shown, a single drive can be used to change the orientation of a linear frame structure, and two or more different frame structures can be rotated together.

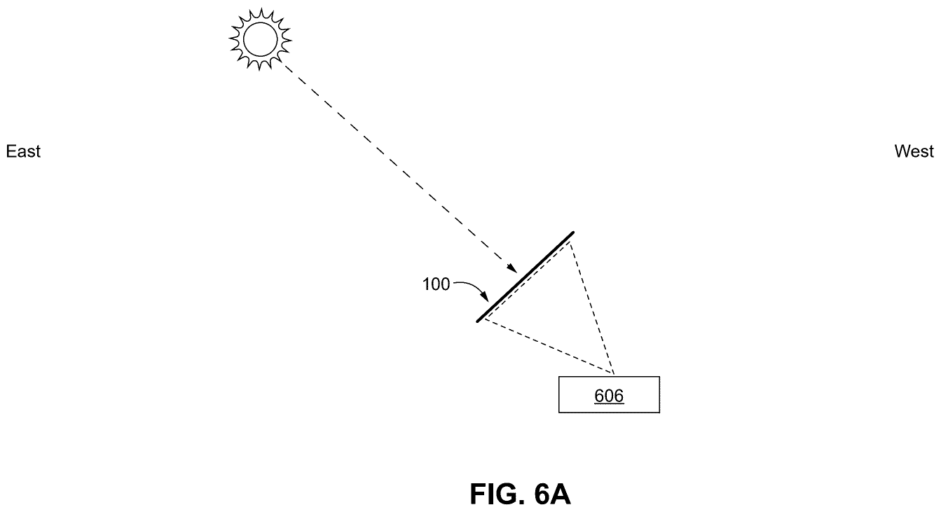

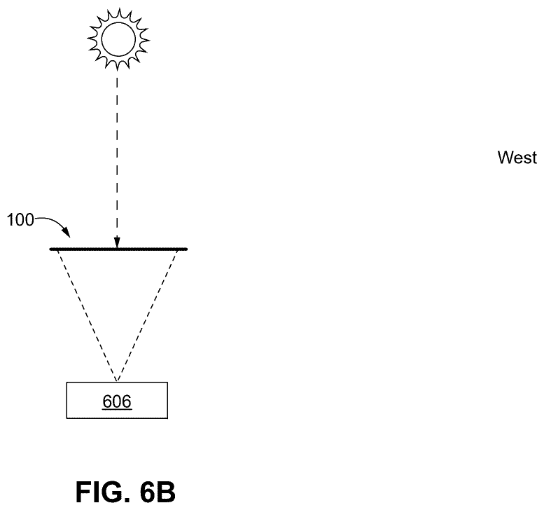

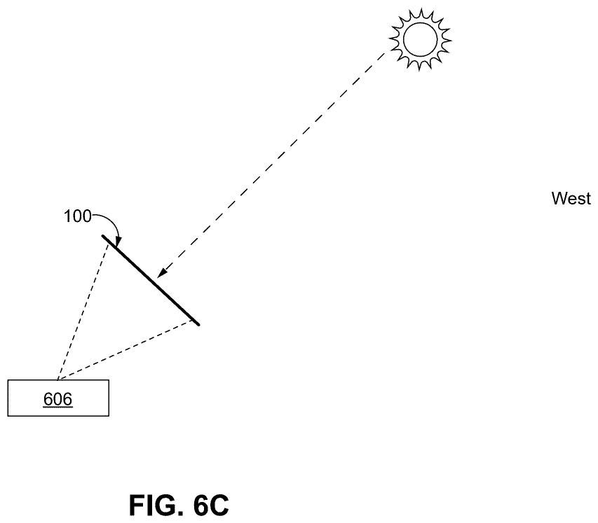

In one embodiment, the upright posts (and associated support structure) are installed in a suitable direction (compass bearing) based on the latitude of the collector installation. Then, a controller operating the drive sets the rotational angle of the uprights based on the time of day and day of the year (as programmed into a computer or controller based on the latitude) to track the sun's position as it moves (traces a path) in the sky. See FIGS. 6A, 6B, 6C. The sun's position at a given time of day will trace a figure eight in the sky over the course of a year, and the controller can take this variation into account in controlling the drive to set elevational orientations of the solar collector panels.

In one embodiment, the collector array is installed so the panels can automatically track the sun's position as the sun moves from east to west. The controller is also able to position the Fresnel lens array in a vertical or other rest orientation during the night. In some embodiments, the controller may include a wind speed and direction detector (or receive this information from a remote weather monitoring source over a network) to position the array in an orientation that reduces likelihood of wind damage based on wind direction.

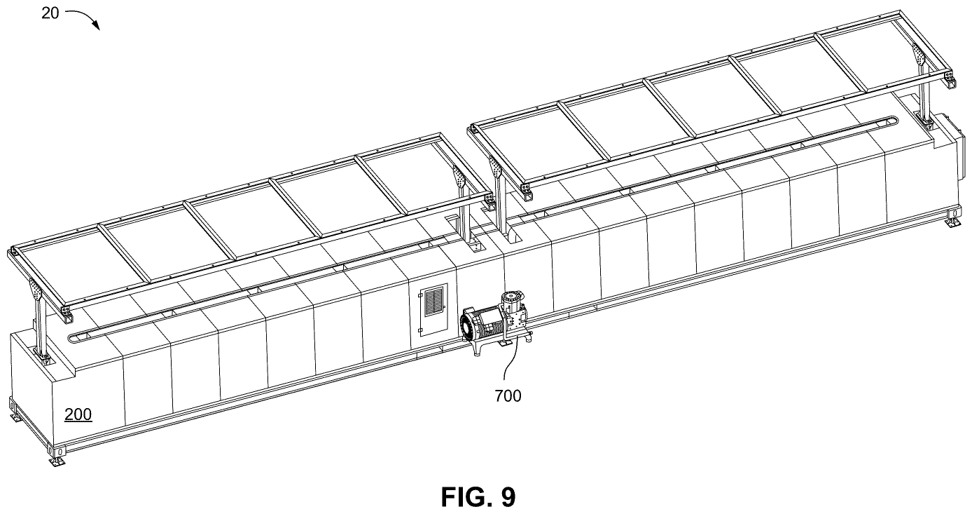

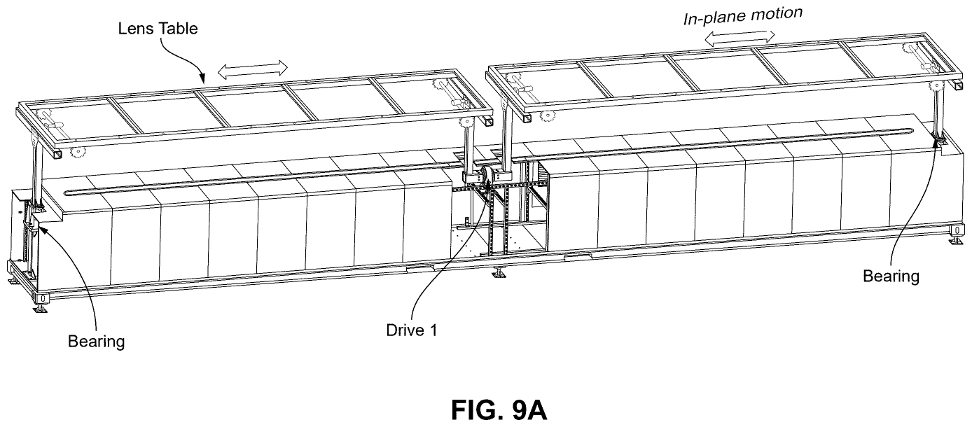

In the embodiment shown in FIG. 3, solar collection platform (SCP) 20 includes an elongated housing 200 supported by a ground frame 202. The elongated housing 200 supports a linear array of Fresnel lenses 100. The linear array of Fresnel lenses 100 are encased in and supported by a movable frame(s) 600. In example embodiments, the movable frame(s) 600 is/are rotatable about the longitudinal axis of the elongated housing 200. A drive(s) 604 is provided to rotate the movable frame(s) 600 about that longitudinal axis. See FIG. 9.

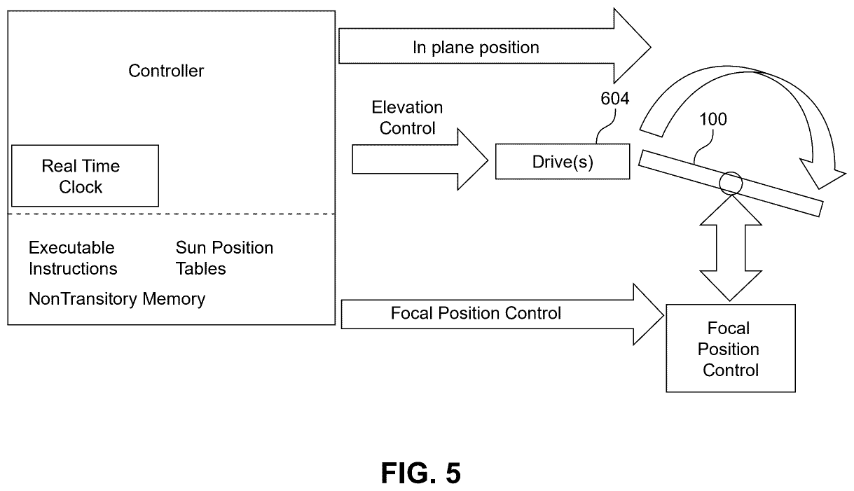

The single point drive(s) 604 is/are controlled by an electronic controller shown in FIG. 5 comprising a CPU, a processor and/or an electronic circuit including a real time clock. The controller computes or looks up the position of the sun in the sky based on time of day, day of year and geolocation of the SCP. The controller operates the drive(s) 604 to continually change the orientation angle of the Fresnel lenses 100 to track (maintain a normal orientation to) the sun's position as the sun moves in the sky, in order to efficiently collect and focus solar energy from the sun onto absorber structures 606 disposed on or accessible through a top surface of elongated housing 200.

In one embodiment, the system is calibrated based on the particular installation orientation of the solar collection array relative to the surface of the earth so an electronic controller can e.g., perform a lookup in a table (the angular contents of which depends on latitude) based on (a) time of day and (b) day of year, to position the horizontal positioning actuators so the solar panels are aimed at the current position of the sun. The controller can control the drive to change its position once every few minutes to track the sun's changing elevational position. For example, the lookup table may contain elevational orientations that correlate with spherical or polar coordinates specifying the sun's angular position in the sky at the installation's particular latitude based on time of day and day of the year. The controller may thus include a real time clock/calendar that indexes a lookup table or other data source to determine the correct elevational orientation of the frame and Fresnel lenses for the particular time/date. In one embodiment, a linear position sensor or encoder may be used to sense elevational orientations of the solar panels or associated carrying frame structures to ensure accurate tracking.

The system as described provides efficient solar tracking across a range of medium latitudes. For installation in higher or lower latitudes, one embodiment enables manual setting of the rotational orientations of the panels depending on the season of year. For example, three orientation settings (summer, winter and spring/fall) might be used in higher or lower latitudes to increase tracking accuracy of the sun's seasonally-changing arc across the sky.

FIGS. 6A, 6B and 6C are together a flip chart animation showing example rotation by drive(s) 604 of the Fresnel lens panel 100 as the sun's position changes from morning (FIG. 6A) to midday (FIG. 6B) to afternoon (FIG. 6C). In example embodiments, the electronic controller controls the drive(s) 604 to maintain the surfaces of the Fresnel lenses 100 to be approximately perpendicular to the sun's position as the sun moves in the sky. This means the sun's rays strike the surface of the lenses 100 in a direction that normal to the lens surfaces. In these embodiments, to keep the system rugged and simpler, the drive(s) 604 rotates the Fresnel lens frame(s) 600 about only one axis to track the sun's changing elevation in the sky. Thus, the drive(s) 604 may rotate through a range of angles from dawn to dusk, presenting the flat surfaces of the Fresnel lenses 100 to illumination by the sun such that the Fresnel lenses 100 collect and focus the sun's rays onto absorber structures 606.

### Horizontal Longitudinal Adjustment/In-Plane Motion

A challenge of a single axis tracking system is that the sun constantly changes in both azimuth and elevation as it traces a path through the sky whereas the single axis tracking system can typically change only in elevation angle. Therefore, in a general case, the direction of the sun's rays on any given day and time will not be perfectly normal to the Fresnel surface of single-axis tracking Fresnel lenses 100 but will instead be incident off axis to some degree. This off axis incidence deviation tends to worsen at the beginning and the end of each day, resulting in defocusing of the concentrated solar energy incident on the absorbers and decreasing efficiency. In particular, a change in focal position is caused by the change of refraction condition inside the prisms of the Fresnel lenses 100. See Liang et al, Concentrating behavior of elastic Fresnel lens solar concentrator in tensile deformation caused zoom, Renewable Energy Volume 29 Jun. 2023, Pages 471-480, //doi.org/10.1016/j.renene.2023.04.013:
research shows that the daily working hours of a single-axis tracking Fresnel lens solar concentrator are quite short, which leads to a low return on investment. The short daily working hours of a single-axis tracking Fresnel lens are caused by Fresnel lens focal length change during light off-normally incidence. The off-normal incidence will inevitably occur in the morning and afternoon, and the focal length will change shorter. As a result, the stationary installed receiver cannot intercept the converged sunlight totally. Consequently, we argue that focal length change is the critical factor hindering the large-scale application of Fresnel lenses in solar concentration.

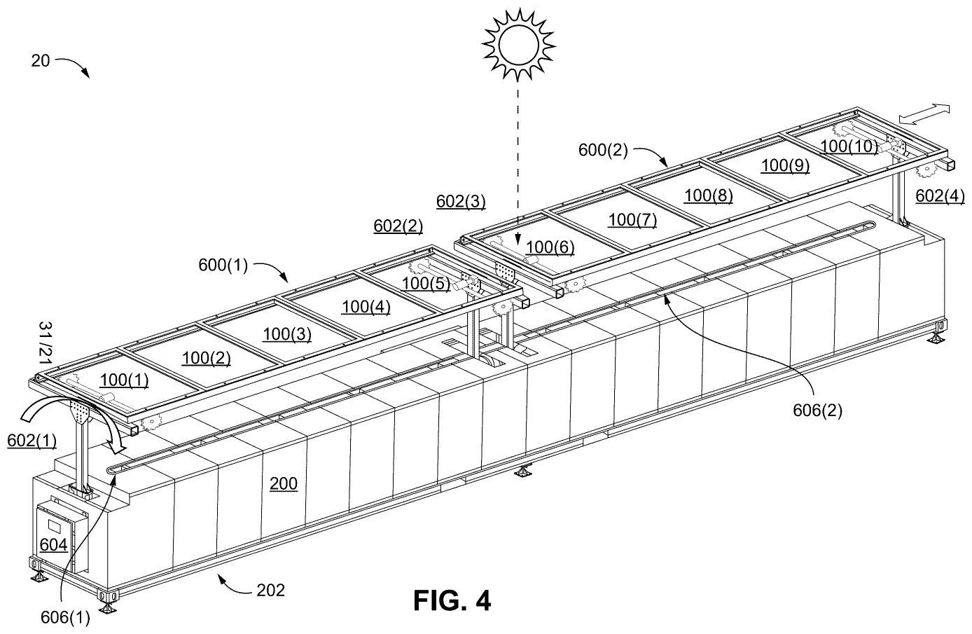

To solve the above challenge, some example embodiments (as shown in FIG. 4) include an additional, automatic horizontal longitudinal position control for the Fresnel lens panel(s). Such an additional horizontal longitudinal position adjustment can be accomplished as shown in FIG. 4 by mounting the Fresnel lens frame(s) on rotatable sprockets or other mechanisms that permit the lens frames to move linearly along their longitudinal axis (axes). One or more linear actuators can be used to control the linear longitudinal position of the lens frames. Such position can be changed to alter the focal point of each lens—which can be particularly helpful when the sun is at low angles (closer to dawn or to dusk).

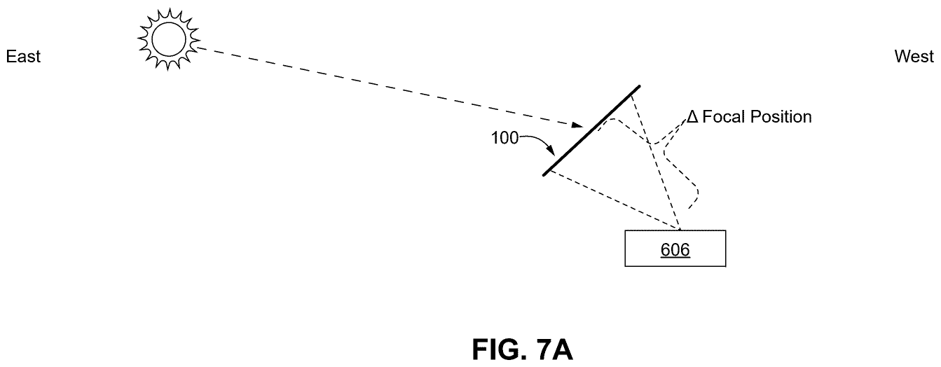

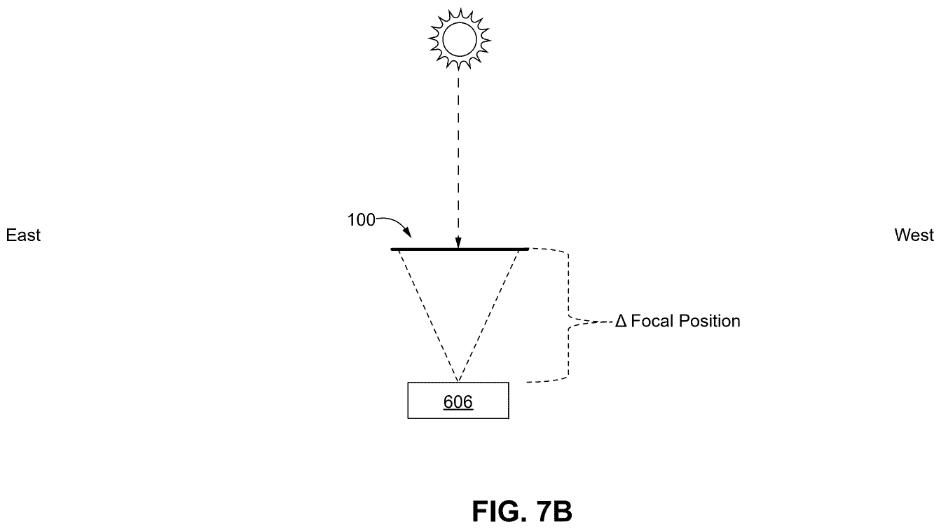

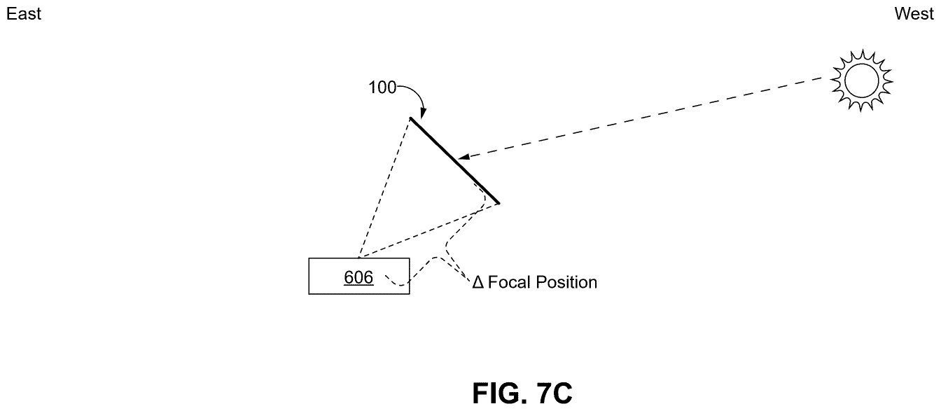

The automatic longitudinal position control (which is also synchronized to the time of day, day of the year, and geolocation of the SCP) thus controls a longitudinal positional offset of each Fresnel lens 100 relative to its absorber 606 in order to provide better focus of concentrated rays onto the absorber 606 for off-axis sun positions the Fresnel lens with single axis tracking is unable to perfectly track. FIGS. 7A, 7B, 7C show an example flip chart animation of focal position adjustment applied in combination with a single Fresnel lens 100 orientation adjustment to account for off-axis solar rays. The resulting tracker is a 1½ axis control of sorts, where the elevation control controls the elevational position of the lenses 100 and the linear control changes the precise position of the focal points of the lenses.

Referring again to FIGS. 3 & 4, example SCP embodiments 10, 20 can support a single Fresnel lens 100 support frame 600 (FIG. 3) or multiple support frames 600(1), 600(2), 600(N) (FIG. 4). In the FIG. 3 example, a single rotatable support frame 600 supports eleven Fresnel lens panels 600(1), . . . , 600(11). In the FIG. 4 example, two rotatable support frames 600(1), 600(2) each support five Fresnel lens panels (600(1), 600(2), 600(3), 600(4), 600(5), and 600(6), 600(7), 600(8), 600(9), 600(1), respectively). In the FIG. 4 multi-frame example, separate drives 604 or a common drive can be used to drive and position the multiple frames. An advantage of the multi-frame approach of FIG. 4 is that each frame is lighter and/or can be made more rugged to withstand wind and weather.

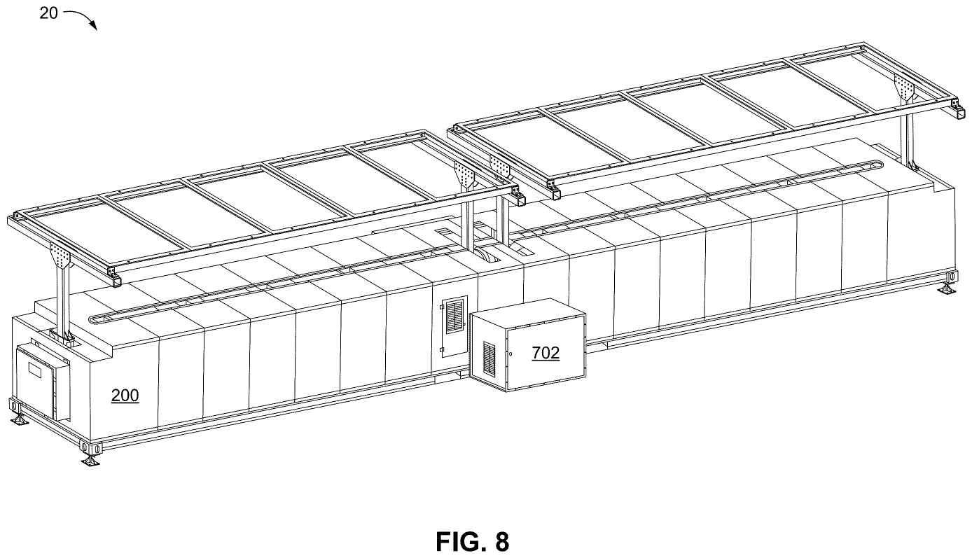

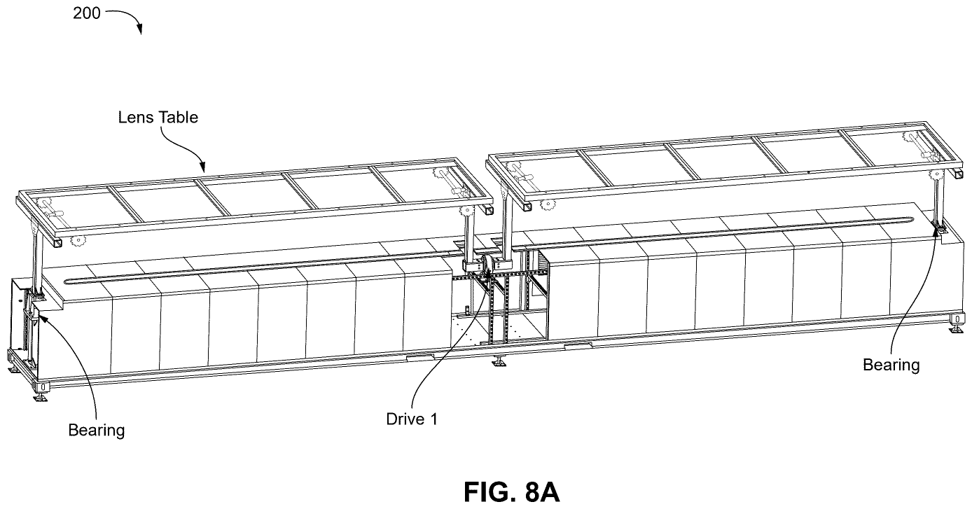

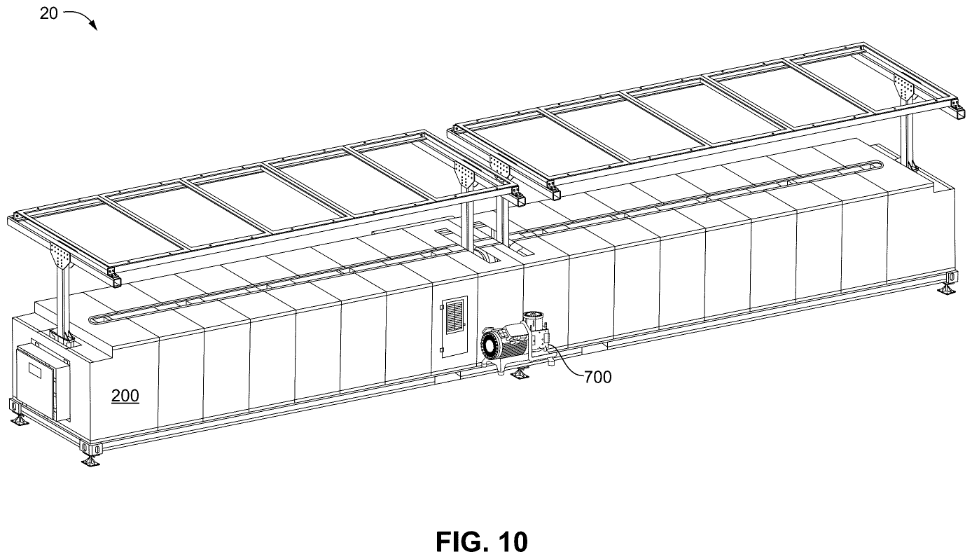

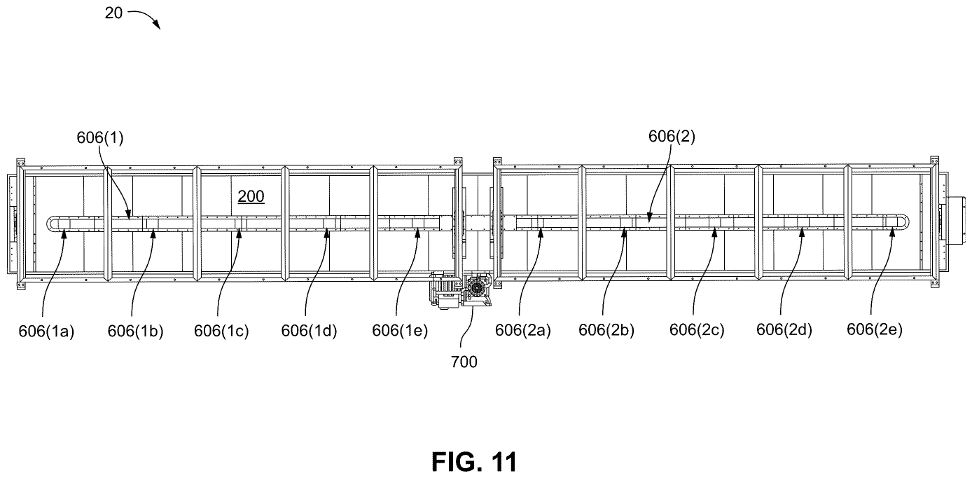

FIGS. 8, 8A, 9, 9A, 10 and 11 show additional views of the SCPs 10, 20. In particular:

FIGS. 8, 9,10 & 11 show a collection platform with two separate lens frames and no longitudinal position control

FIG. 8A, 9A show a collection platform with two separate lens frames and including longitudinal position control

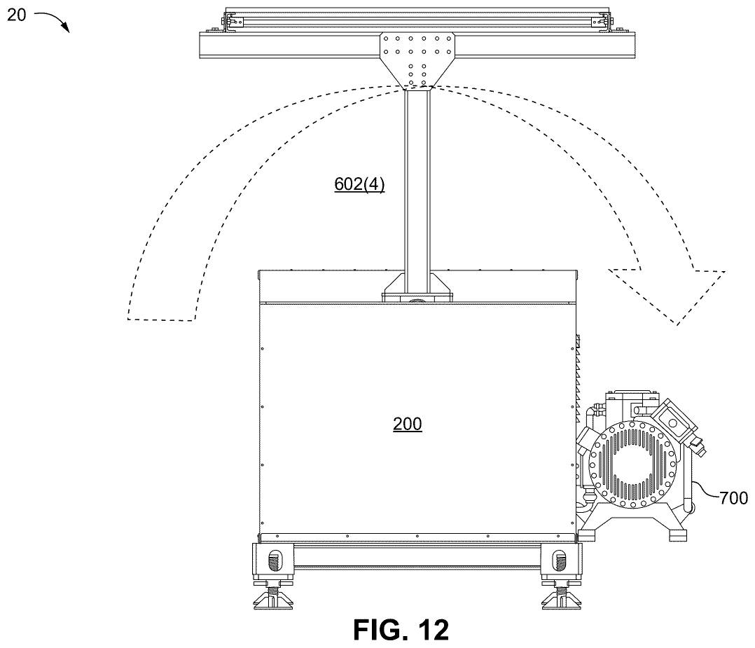

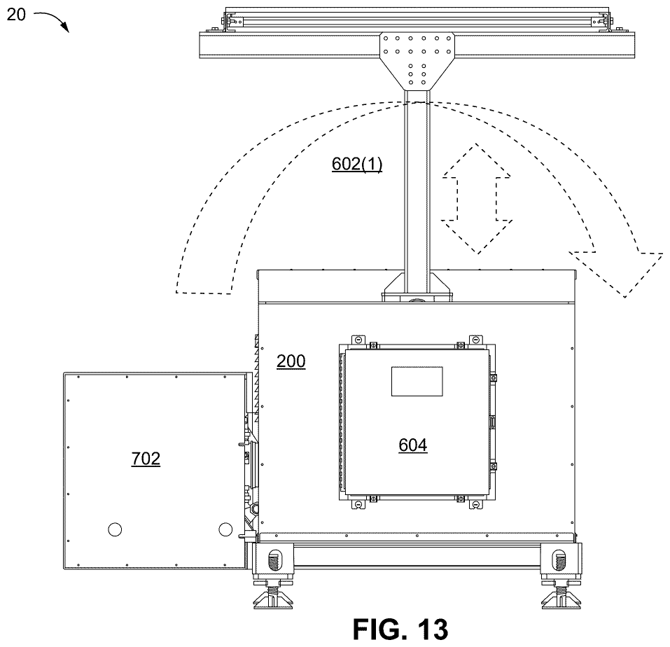

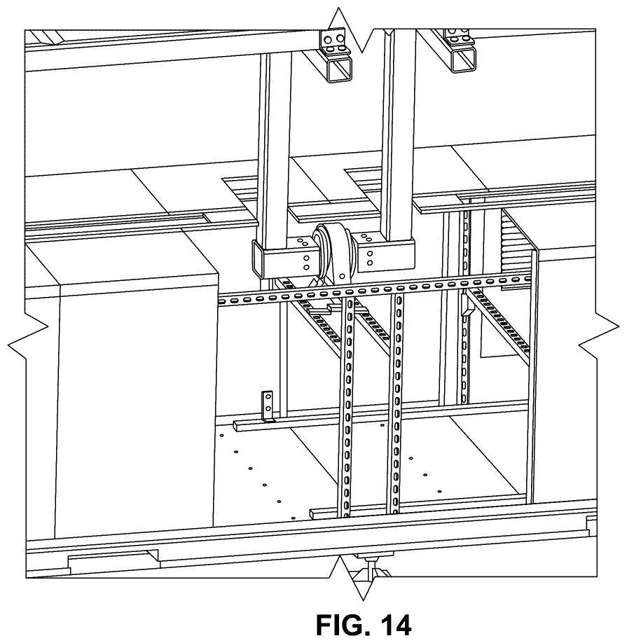

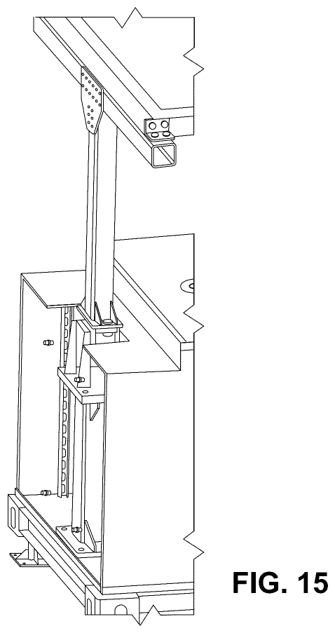

FIG. 12 shows an external housing 200 that may contain the Stirling engine 700 better seen without its external housing.

### Example Distributed Thermal Battery Storage

FIG. 4 meanwhile shows discrete absorbers 606(1a), 606(1b), etc. arranged along a longitudinal absorber aperture or slot 606(1), and discrete absorbers 606(2a), 606(2b), etc. arranged along a longitudinal absorber aperture or slot 606(2). Thus, in this embodiment, the SCP housing 200 houses a thermal storage system 300 comprising a longitudinal array of thermal storage devices that are thermally coupled together with working fluid flow between them.

In particular, the housing is insulated, and contains a plurality of thermal battery cells—one for each Fresnel lens. An opening on the top surface of the housing for each Fresnel lens (there can be different openings for different Fresnel lens, or the opening can be a longitudinal channel axial to the housing) admits the focal point of the Fresnel lens to the interior of the housing where it strikes a receiving area of a corresponding internal thermal battery cell. The receiving area can be an optical grating used to trap the energy, reflecting it several times within the grating to thereby transfer heat to the grating and thus to the thermal battery cell. The thermal battery cell can be made of any of a variety of suitable heat retaining materials. The material of the thermal battery cell retains the head captured by its heat receiving portion, and retains the heat until it is removed by flowing a working fluid such as air through internal passages within the battery cell. The battery cells meanwhile can be arranged in a line in contact with one another such that air can travel through first one battery cell, then through another adjacent cell, and so on. In one embodiment, the flow can be channeled so air flows plural (two) times through the entire line of battery cells to transport heat from each of the battery cells in the line to the thermal load. The air flow can be flow-controlled and turned on and off by activating/deactivating (and controlling the speed of rotation of) a blower.

The battery cells in one embodiment contain electrical heating elements to heat the battery cells when the sun is not shining. In example embodiments, these discrete battery cells are integral parts of a thermal battery cell system described in more detail in the above-referenced patent applications such as “Thermal Battery Pack”; “Thermal Battery Pack Recirculating Housing”; and “Integrated Thermal Energy Collection, Storage, and Discharge Device”, incorporated herein by reference.

All patents and publications cited herein are incorporated by reference.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A solar collector comprising:
at least one heat absorber;
an array of lens panels carried by at least one frame;
a frame support enabling the lens panels to rotate;
a single-axis automated drive mechanism connected to the frame support, the single-axis automated drive mechanism rotating the frame support to track, based on season, elevation of the sun with a field of view of the lens panels; and
a focal position control enabling adjustment of focal position of the lens panels onto the the heat absorber by changing the horizontal position of the lens panels relative to the heat absorber.

2. The solar collector of claim 1 wherein the heat absorber comprises a linear array.

3. The solar collector of claim 1 wherein the lens panels comprise Fresnel lens panels.

4. The solar collector of claim 1 wherein the focal position control is automatic.

5. The solar collector of claim 1 wherein the focal position control is manual.

6. The solar collector of claim 1 wherein the single-axis automated drive mechanism comprises a tracking computer connected to an electromechanical drive.

7. The solar collector of claim 1 wherein the array of lens panels comprises a longitudinal array of many lens panels aligned on a longitudinal axis, the single axis drive mechanism rotates the frame about the longitudinal axis, and the focal position control moves the lens panels linearly along the longitudinal axis.

8. The solar collector of claim 1 wherein the heat absorber comprises a thermal battery.

9. The solar collector of claim 1 wherein the single axis automated drive mechanism rotates the frame support to thereby rotate the array of lens panels through a range of elevation angles from dawn to dusk.

10. A solar collection method comprising:
providing an array of lens panels carried by at least one frame supported by a frame support enabling the lens panels to rotate;
automatically rotating the frame support in a single axis to track, based on season, elevation of the sun with a field of view of the lens panels; and
enabling linear adjustment of position between the frame support and a heat absorber.

11. The solar collection method of claim 10 wherein the heat absorber comprises a linear array.

12. The solar collection method of claim 10 wherein the lens panels comprise Fresnel lens panels.

13. The solar collection method of claim 10 wherein the adjustment enabling is automatic.

14. The solar collection method of claim 10 wherein the adjustment enabling is manual.

15. The solar collection method of claim 10 wherein the automatically rotating is performed by single-axis automated drive mechanism comprising a tracking computer connected to an electromechanical driver.

16. The solar collection method of claim 10 wherein the array of lens panels comprises a longitudinal array of many lens panels aligned on a longitudinal axis.

17. The solar collection method of claim 10 wherein the heat absorber comprises a thermal battery.

18. The solar collection method of claim 10 wherein the automatically rotating comprises rotating the frame support to thereby rotate the array of lens panels through a range of elevation angles from dawn to dusk.

19. A system comprising:
a first heating stage providing a first heated medium output;
a second heating stage thermally coupled to receive the first heated medium output, the second heating stage further heating the first heated medium output to provide a second, cumulative heated medium output;
wherein the first and second heated stages are incorporated into a standard sized shipping container form factor containing a distributed thermal storage, and
the first and second heating stages each comprise rotatable Fresnel lens arrays.
